(19) United States
(12) Patent Application Publication
(10) Pub. No.: US 2019/0152860 A1
(43) Pub. Date: May 23, 2019

(54) SPINEL REFRACTORY GRANULATES WHICH ARE SUITABLE FOR ELASTICIZING HEAVY-CLAY REFRACTORY PRODUCTS, METHOD FOR THEIR PRODUCTION AND USE THEREOF

(71) Applicant: Refratechnik Holding GmbH, Ismaning (DE)

(72) Inventors: Heinrich Liever, Dransfeld (DE); Hilmar Schulze-Bergkamen, Auckland (NZ); Carsten Vellmer, Göttingen (DE)

(21) Appl. No.: 16/301,786

(22) PCT Filed: Mar. 23, 2017
(86) PCT No.: PCT/EP2017/056999

§ 371 Date: Nov. 15, 2018

(30) Foreign Application Priority Data
May 19, 2016 (DE) 10 2016 109 258.4

(51) Int. Cl. C04B 35/047; C04B 35/101; C04B 35/26; C04B 35/443; C04B 35/626; C04B 35/64

(52) U.S. Cl. CPC C04B 35/0473; C04B 2235/9607; C04B 35/26; C04B 35/443; C04B 35/6265; C04B 35/62695; C04B 35/64; C04B 2235/3206; C04B 2235/3208; C04B 2235/3217; C04B 2235/3272; C04B 2235/5427; C04B 2235/5472; C04B 2235/6583; C04B 2235/763; C04B 2235/77; C04B 2235/782; C04B 2235/80; C04B 35/101

(57) ABSTRACT

The invention relates to a granular, refractory mineral elasticizing granulate for refractory products, in particular for basic refractory products. The minerals consist of mono-phased fused spinel mixed crystal or multi-phased fusion products of the ternary system MgO−Fe₂O₃—Al₂O₃ of the composition range
MgO: 12 to 19.5, in particular 15 to 17 wt.- %,
Remainder: Fe₂O₃ and Al₂O₃ in a quantity ratio range of Fe₂O₃ to Al₂O₃ between 80 to 20 and 40 to 60 wt.- %.

Starting from an MgO content between 12 and 19.5 wt.- %, the respective mixed crystals have an Fe₂O₃ and Al₂O₃ content in a solid solution out of the limited ranges respectively indicated thereof, such that a total composition of 100% is obtained. In addition, the invention relates to a method for production of the elasticizing granulate and to the use thereof.

### CROSS-REFERENCE TO RELATED APPLICATIONS

This application is a 35 U.S.C. § 371 national phase application of International Application No.: PCT/EP2017/056999, filed Mar. 23, 2017, which claims the benefit of priority under 35 U.S.C. § 119 to German Patent Application No.: 10 2016 109 258.4, filed May 19, 2016, the contents of which are incorporated herein by reference in their entirety.

### FIELD OF THE INVENTION

The invention relates to refractory spinel granulates which are suitable for elasticizing of coarse-ceramic, in particular basic, refractory products, to a method for production thereof and their use in coarse-ceramic, in particular basic refractory products containing spinel elasticizer.

### BACKGROUND

The statements in this section merely provide background information related to the present disclosure and several definitions for terms used in the present disclosure and may not constitute prior art.

Ceramic refractory products are based on refractory materials, e.g. on basic, refractory materials. Basic refractory materials are materials in which the sum of the oxides MgO and CaO clearly predominate. They are listed, for example, in tables 4.26 and 4.27 in the “Taschenbuch Feuerfeste Werkstoffe, Gerald Routschka, Hartmut Wuthnow, Vulkan-Verlag, 5th edition.”

Elasticizing spinel granulates—hereinafter also called merely “spinel elasticizers” or “elastifiers”—which are usually employed in the form of coarse-grained granulates, are in a, e.g. basic, coarse-ceramic refractory product which comprises at least one refractory, mineral refractory material granulate as main component, these spinel granulates are refractory material granulates comprising a different mineral composition in comparison to the main component. The granulates are statistically distributed in the refractory product structure and elastify the structure of the refractory product by reducing the E- and G-modulus and/or by reducing the brittleness of the refractory product and thereby increase the resistance to temperature change or the resistance to temperature shock, for example due to formation of microcracks. Generally they determine the physical or mechanical and thermo-mechanical behavior of a basic refractory product which comprises as main component at least one granular, e.g. basic, refractory, mineral material. Elastifiers of this kind are, for example, MA-spinel, hercynite, galaxite, pleonaste, but also chromite, picrochromite. They are described, for instance, in section 4.2 of the handbook referenced above, in connection with various, for example basic, coarse-ceramic refractory products.

For example, standard granulations of granular spinel elastifiers are known to lie primarily between 0 and 4 mm, in particular between 1 and 3 mm. The granulations of the main component of the refractory products made from e.g. basic, refractory materials are known to lie primarily between 0 and 7 mm, and in particular between 0 and 4 mm, for example. The term “granular” is used hereinafter basically in contrast to the term meal or powder or meal fine” or “powdery”, wherein the terms meal or fines or finely divided are supposed to mean granulations of less than 1 mm, in particular less than 0.1 mm. Primarily means that every elastifier can comprise subordinated powder fractions and more coarse fractions. But also, every main component can contain meal or powder fractions up to e.g. 35 wt- %, in particular 20 wt- % and subordinated amounts of more coarse fractions. This is because we are dealing with industrially obtained products which can only be produced with limited accuracies.

Coarse-ceramic refractory products are primarily shaped and non-shaped, ceramically fired or non-fired products, which are obtained by a coarse-ceramic production method that uses grain sizes of the refractory components of e.g. up to 6 mm or 8 mm or 12 mm (Taschenbuch, page 21/22).

The refractory main component—also called the resistor—and/or the refractory main components of such e.g. basic refractory products, essentially guarantee the desired refractoriness and the mechanical and/or physical and chemical resistance, whereas the elastifiers, in addition to their elasticizing effect, likewise also support the mechanical and thermo-mechanical properties, but also possibly are provided to improve the corrosion resistance and also to enhance the chemical resistance to alkalis and salts, for instance. Generally the fraction of refractory main component predominates, that means it amounts to more than 50% by mass in the refractory product, so that accordingly the content of elastifier generally lies in a range below 50% by mass.

Refractory elastifiers—also called microcrack-formers—are described for coarse-ceramic refractory products in DE 35 27 789 C3, DE 44 03 869 C2, DE101 17 026 B4, for example. Accordingly, these are refractory materials which increase the resistance of the structure of the refractory, e.g. basic, products to mechanical and thermo-mechanical stresses, in particular by reducing the E-modulus, and at least do not adversely affect the resistance to chemical attack, for example, to slag attack and to attack by salts and alkalis. As a rule, the causes for the elasticizing are disruptions in the lattice such as stress cracks and/or microcracks which make it possible that externally applied stresses can be dissipated.

It is known that basic refractory products containing aluminum oxide generally possess the sufficient mechanical and thermo-mechanical properties for their use e.g. in the cement, lime or dolomite industries at high operating temperatures around 1,500° C. These products are commonly elastified by the addition of aluminum oxide and/or magnesium aluminate spinel (MA-spinel) to burnt magnesia or fused magnesia. Refractory products of this kind, based on magnesia, require low contents of calcium oxide (CaO), which is only possible through the use of well-processed, expensive raw materials. In the presence of calcium oxide, aluminum oxide and MA-spinel form fused CaO—Al₂O₃ and thus negatively affect the brittle-ness of the ceramic products.

In addition, in industrial furnace systems, for example, in cement kilns, at high temperatures reactions occur between aluminum oxide, in-situ spinel or MA-spinel and the fused cement clinker containing the CaO to produce minerals, e.g. Mayenite (Ca₁₂Al₁₄O₃₃) and/or Ye'elimite (Ca₄Al₆O₁₂(SO₄)), which can result in a premature wear of the furnace lining. In addition, dense and low-porosity magnesia spinel-stones which contain either sintered or molten MA-spinel (magnesium aluminate spinel) as an elasticizing component, comprise a low tendency to form a stable deposited layer which forms on the refractory lining from fused cement clinker during operation and is desirable in the cement rotary kiln.

These disadvantages have led to the decision to employ hercynite (FeAl2O4) as an elastifier, namely in refractory products for the firing zones in cement rotary kilns, which products, due to the iron content of the elastifier, comprise a clearly improved crusting ability and in the case of synthetic hercynite (DE 44 03 869 C2) or iron oxide-aluminum oxide granulate (DE 101 17 026 A1), are added to the ceramic batch mass of the refractory products.

However, varying redox conditions which occur, for example, in the furnaces of the cement, dolomite, limestone and magnesite industries, in the case of hercynite-containing lining stones, lead to an adverse exchange of aluminum ions and iron ions at high temperatures. At temperatures above 800° C. a completely solid solution can take place within the material system of FeAl2O4 (hercynite)—Fe3O4 (magnetite) in the hercynite crystal, wherein below 800° C. a two-phase system with excreted magnetite forms, which causes an undesirable chemical and physical vulnerability of hercynite in refractory products under certain redox conditions.

The use of alternative fuels and raw materials in modern rotary furnaces, e.g. in the cement, limestone, dolomite or magnesite industry, results in considerable concentrations of alkalis and salts from various origins in their atmosphere. Hercynite is known to decompose at typical operating temperatures when exposed to oxygen and/or air to form FeAlO₃ and Al₂O₃. These multi-phased reaction products react with alkali compounds and salts to form additional secondary phases, which in turn, leads to an embrittlement of the refractory product and limits its use.

A multiple phase system of this kind also appears during the production of hercynite, during the sintering or fusing, namely due to oxidation during cooling. After cooling, a multi-phased product is present, with hercynite as main phase, and in addition, so-called secondary phases are also present. When using refractory products containing hercynite as an elastifier, that is, in situ in operating cement rotary kilns, for example, the production-related secondary phases also act like the secondary phases produced from hercynite at operating temperatures as described above, and have an embrittling effect.

To prevent the oxidation, it has been proposed according to CN 101 82 38 72 A to produce hercynite as a mono-phase, by carrying out the ceramic firing in a nitrogen atmosphere. But this method is very complicated and indeed can ensure a mono-phase of the hercynite, but this is nonetheless unstable in situ, and comprises a deficient resistance under oxidizing conditions in a furnace system.

The invention according to DE 101 17 026 B4 describes an alternative to the hercynite, in that as an elastifier, a synthetic refractory material of the pleonastic spinel type is proposed with the mixed crystal composition of (Mg²⁺, Fe²⁺) (Al³⁺, Fe³⁺)₂O₄ and MgO-contents of 20 to 60 wt- %. In the literature, the continuous ex-change of Mg²⁺- and Fe²⁺-ions in the transition from spinel sensu stricto (ss) MgAl2O4 toward hercynite (FeAl₂O₄) is described, wherein members of this series with Mg²⁺/Fe²⁺-ratios from 1 to 3 are designated as pleonaste (Deer et al., 1985 Introduction to the rock forming minerals). Compared to sintered or fused hercynite, these elastifiers comprise an improved resistance to alkali or clinker melts (Klischat et al., 2013, Smart refractory solution for stress-loaded rotary kilns, ZKG 66, pages 54-60).

In the case of the pleonaste resulting from the fusing or of the pleonastic spinels with 20-60 wt- % of MgO, the three mineral phases of MgFe₂O₄ss, MgAl₂O₄ and periclase are present, for example. The existence of these mineral phases results from an energy-intensive production process using components from the ternary system of MgO—Fe₂O₃—Al₂O₃ with disturbing secondary phases. Sintering and/or fusing in a smelting system, e.g. in an electric arc furnace, leads to a considerable quantity of secondary phases, such as FeO dissolved in MgO (MgOss, magnesiowüstite) and results in a complex mixture of several mineral phases.

DE 101 17 026 B4 describes that the modulus of elasticity (E-modulus) of examined refractory bricks is directly proportional to the increasing MgO content of the pleonastic spinel employed in them. An increase from 20 to 50 wt- % MgO in the examples caused an increase in the E-modulus from 25.1 to 28.6 GPa. The quantities of pleonastic spinel chosen here in many cases simultaneously cause the generation of mineral phases such as periclase (MgO), Magnesiowüstite (MgO ss) and Magnesioferrite (MgFe₂O₃), which—as inherent constituents—affect the expansion coefficient of the spinel and can have an adverse effect on the brittleness of the refractory product containing the spinel.

In determinations of ignition loss according to DIN EN ISO 26845:2008-06 at 1.025° C., hercynite and pleonaste comprise an ignition gain of up to 4% or up to 2%, respectively. Under oxidizing conditions and at corresponding temperatures, the crystal lattice of hercynite decomposes. In the case of pleonaste, the Magnesiowüstite is converted into magnesioferrite.

### SUMMARY

The object of the invention is to create spinel elastifiers having a lower oxidation potential and/or being more oxidation-resistant, being better, and permanently more elastifying especially in basic refractory products, which elastifiers preferably provide in addition to the good elastifying properties, also a good thermo-chemical and thermo-mechanical resistance and a uniform elastifying ability at lower contents in comparison to the hercynite or pleonaste contents, for example—especially in basic refractory products, in particular when the refractory products containing them are used in cement rotary kilns, wherein they are furthermore intended to cause a good crust formation. An additional object of the invention is to create coarse-ceramic, basic refractory products and uses for them, which are superior—due to their content of at least one elastifier granulate of the invented type—to the known coarse-ceramic, in particular basic, refractory products in regard to oxidation resistance and also in regard to thermo-chemical and thermo-mechanical resistance and crust formation in situ.

The invention also relates to elastifying spinel granulates produced by a fusing method in neutral or reducing atmosphere, with compositions of the spinel selected according to the invention in the ternary system of MgO—Fe₂O₃—Al₂O₃. In addition to the particular main mixed crystal spinel phase, mineral secondary phases, such as Magnesiowüstite and Magnesioferrite, for example, result from the fusing process. Thus the fusing process generates a multiple-phased mineral fused product, which after cooling, is subjected to a crushing and fractioning process. The granulate obtained in this manner can be added to refractory products as an elastifying, refractory material. If these products are used, for example as a refractory lining in a large-volume industrial furnace, then they act in situ in the known manner as an elastifiers at high application temperatures (e.g. above 1000° C.).

In a neutral or reducing furnace atmosphere, the mineral phases of the fused product act like elastifiers. But the use of the granulates from the multi-phased fused products in refractory products is particularly advantageous when such products are used in situ in an oxidizing atmosphere. This is because in this case, due to high temperature oxidation in situ, a spinel mono-phase forms from the particular multi-phased fused product, which is resistant in situ and thus remains stable in a granulate containing coarse-ceramic refractory product, in particular in a basic refractory product containing at least one spinel elastifier according to the invention, and ensures the elastification and also the thermo-chemical and thermo-mechanical resistance of the product. In addition, the spinel mono-phase leads to a very good crust formation in a cement rotary kiln.

The existence of a region with spinel mono-phases in the form of complex ternary mixed crystals in the ternary system of MgO—Fe₂O₃—Al₂O₃ has been described by W. Kwestroo, in J. Inorg. Nucl. Chem., 1959, Vol. 9, pages 65 to 70, based on laboratory experiments. Thus, according to FIGS. 1 and 2 op. cit., a relatively large range of molecular weight was found in samples produced in air at firing temperatures of 1250 and 1400° C. and determined by x-ray analysis, in which stabile spinel mono-phases of different composition are found to exist. It was determined therein that the magnetic saturation or the Curie temperature of the particular mono-phase can be a function of the chemical composition. Additional properties of the mono-phases were not investigated or stated. The mono-phases comprise different quantities of (Al, Fe)₂O₃ in solid solution in the spinel crystal.

Further areas of applicability will become apparent from the description provided herein. It should be understood that the description and specific examples are intended for purposes of illustration only and are not intended to limit the scope of the present disclosure.

### BRIEF DESCRIPTION OF THE DRAWINGS

FIG. 1 shows the range of composition found in wt- % for the mono-phased spinel mixed crystals suitable as elastifiers as an ESS bounded quadrilateral within the ternary system of MgO—Fe₂O₃—Al₂O₃, whereas the range of composition of the known pleonastic spinel elastifier is indicated as a pleonaste-bounded rectangle.

FIG. 2 shows the x-ray powder diffractogram of sample 1 after high-temperature oxidation.

FIG. 3 shows the x-ray powder diffractogram of sample 1.

FIG. 4 shows the x-ray powder diffractogram of sample 2.

FIG. 5 shows reflected light microscopy of sample 1 fused in an electric arc furnace.

FIG. 6 shows reflected light microscopy of sample 2 fused in an electric arc furnace.

The drawings are provided herewith for purely illustrative purposes and are not intended to limit the scope of the present invention.

### DETAILED DESCRIPTION

The following description is merely exemplary in nature and is in no way intended to limit the present disclosure or its application or uses. It should be understood that throughout the description, corresponding reference numerals indicate like or corresponding parts and features.

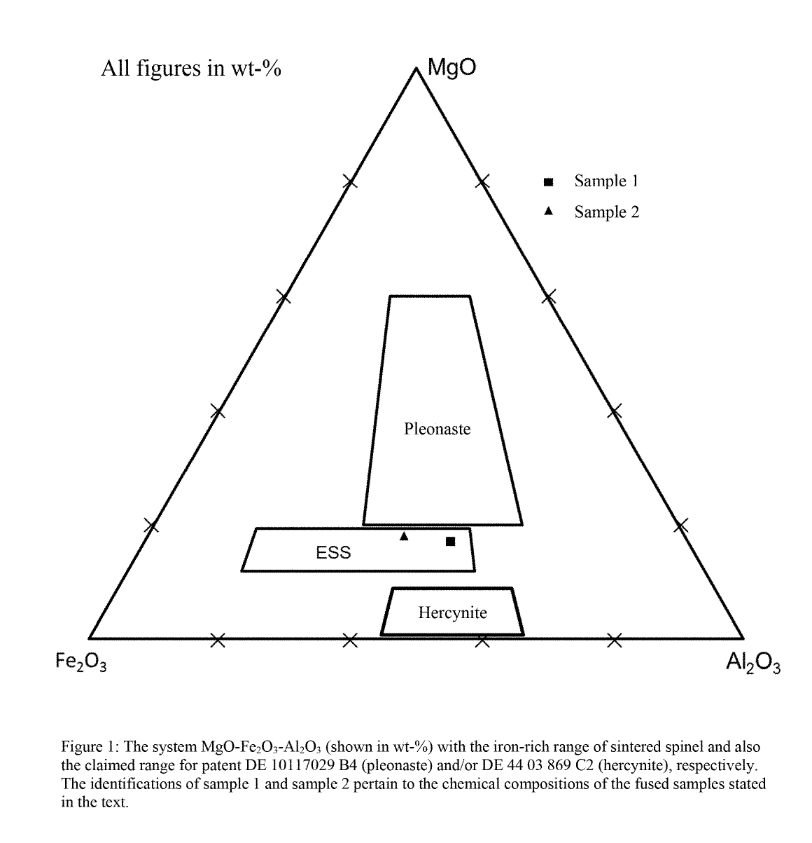

Within the scope of the invention, in the ternary system of MgO—Fe₂O₃—Al₂O₃ a tight range of composition of mono-phased, stable mixed spinel crystal was found in the known, broad range of spinel mono-phases with mono-phased sintered spinel mixed crystals suitable as an elastifier, having the following composition according to the range in FIG. 1:
MgO: 12 to 19.5, in particular 15 to 17 wt.- %,
Remainder: Fe₂O₃ and Al₂O₃ in a quantity ratio range of Fe₂O₃ to Al₂O₃ Between 80 to 20 and 40 to 60 wt.- %.

The range of the ESS according to the invention is obtained as follows: The minimum and maximum MgO content was determined within the scope of the invention as 12 wt- % or 19.5 wt- %, respectively. The side bounds of the ESS-field are each lines of constant Fe₂O₃/Al₂O₃ratios (wt- %).

Left bound: Fe₂O₃/Al₂O₃=80/20

Right bound: Fe₂O₃/Al₂O₃=40/60

Graphically speaking, these bounds represent a portion of the line connecting the peak of the triangle (MgO) to the base of the triangle. The relationships stated above are the coordinates of the points of the base of the triangle.

Starting from an MgO content between 12 and 19.5 wt.- %, the respective mixed crystals have an Fe₂O₃ and Al₂O₃ content in a solid solution, such that from the limited ranges indicated for each case, a total composition of 100 wt- % is obtained. Thus, with regard to MgO, the compositions always remain in the spinel range of the ternary system between 12 and 19.5 wt- % MgO.

Spinets from the invented range of composition which in granular form have bulk grain densities of at least 3.5, in particular of at least 3.6, preferably of at least 3.8 g/cm³, especially of up to 4.0 g/cm³, quite especially of up to 4.2 g/cm³, measured according to DIN EN 993-18, are particularly suitable as an elastifiers. These elastifiers have an optimum elastifying effect especially when mixed with coarse-ceramic, basic refractory products.

Within the sense of this invention, mono-phased means that in the technically produced mixed spinel crystals according to the invention, there are less than 5, in particular less than 2 wt- % of secondary phases, for example, originating from impurities in the starting materials.

It is an advantage if the grain compressive strength of the granules of the elastifier granulate lies between 30 MPa and 50 MPa, in particular between 35 MPa and 45 MPa (measured according to DIN EN 13005-Appendix C). The granular spinel elastifiers according to the invention are produced and used preferably with the following grain distributions (determined by sieving):
0.5-1.0 mm 30-40 wt.- %
1.0-2.0 mm 50-60 wt.- %

In this regard up to 5 wt-% of granules smaller than 0.5 mm and larger than 2 mm can be present, which then reduce the quantities of the other granules accordingly. The granules are used with the standard, usual grain distributions, in particular Gaussian grain distributions, or with particular, common grain fractions in which certain grain fractions are missing (gap grading), as is current practice.

The mono-phased spinel elastifiers according to the invention can be unambiguously identified by means of x-ray diffraction as exclusively mono-phased, as will be explained below.

In addition, the spinel mono-phases can be analyzed as exclusively present in scanning electron microscopy images and quantitatively the composition of the mixed crystals and/or mono-phases can be determined with an x-ray fluorescence elemental analysis, e.g. with an x-ray fluorescence spectrometer, for example, using the Bruker model S8 Tiger.

FIG. 1 shows the range of composition found in wt- % for the mono-phased spinel mixed crystals suitable as elastifiers according to the invention, as an ESS bounded quadrilateral within the ternary system of MgO—Fe₂O₃—Al₂O₃, whereas the range of composition of the known pleonastic spinel elastifier is indicated as a pleonaste-bounded rectangle. In addition, the typical spinel elastifier composition of the normally used hercynite is indicated as a hercynite-bounded rectangle on the Fe₂O₃—Al₂O₃ composition line of the ternary system.

Thus the invention relates to iron-rich spinels which lie within the ternary system of MgO—Fe₂O₃—Al₂O₃ and which are not assigned either to the hercynite spinels or to those of the pleonaste group. After fusing of the corresponding, high-purity raw materials or starting materials and subsequent oxidation at high temperature, the particular spinel product consists merely of a synthetic mineral mono-phase, and due to the predominance of the trivalent iron (Fe³⁺) it displays little or no oxidation potential. Reactive secondary phases like those frequently encountered in pleonastic or hercynitic spinel types, for example, are not present or are not detected under x-ray, and cannot impact the performance of refractory products containing the inventive spinel products.

If spinels according to the invention are used as elastifying components, even in small amounts, in shaped and non-shaped, in particular basic refractory materials, such as for furnace systems in the cement and limestone or dolomite industry or magnesite industry, then, when standard production methods are used, ceramic refractory products are obtained with a high corrosion resistance to alkalis and salts occurring in the furnace atmosphere. In addition, these refractory products display outstanding thermo-chemical and thermo-mechanical properties and also a strong tendency toward crust formation in the aforementioned industrial furnace systems at high temperatures, whereby the latter properties are probably attributable to relatively high, near-surface iron oxide contents of the refractory product.

According to the invention, spinel granulates that can be used as an elastifiers are found in a limited ternary system that brings in all advantages of chemical resistance, ready crust formation, elasticizing and also a good energy balance due to an economical production method for the refractory material. Thus, the invention closes a gap between hercynite- and pleonaste-spinel elastifiers, without having to deal with the disadvantages of the one or the other.

The spinels are used according to the invention in a granulate form and converted to mono-phases from the fusion products during the ceramic firing or in situ and originate from the ternary material system of MgO—Fe₂O₃—Al₂O₃ and differ essentially from the pleonastic spinels due to the valence of the cations and due to a lower MgO content. A magnesium excess which occurs only in the high-temperature range, does not appear in the ternary system of iron-rich spinel used according to the invention, rather, after the high-temperature oxidation, the latter consists solely of a mineral mono-phase due to the absence of secondary phases such as magnesioferrite, Magnesiowüstite, for example. Therefore, the mono-phased spinels used according to the invention are superior to the pleonastic spinels because the named secondary phases are missing, which comprise coefficients of (longitudinal) expansion which are close to those of magnesia and thus have only a small elastifying effect.

The ecological and economical advantage is that the spinels used according to the invention can be produced by a simple method, which requires a fusing process after processing of three raw material components. Within the scope of the invention it was found that from a mixture of sintered magnesia, for example, naturally occurring iron oxide and/or mill scale plus aluminum oxide will form a mineral mono-phase in situ after melting, cooling, crushing and fractioning and with the action of an oxidizing atmosphere at high temperatures, wherein caustic magnesia, fused magnesia and metallurgic bauxite can also be used as starting materials.

The structural singularity of the invented spinels used as granulate makes it possible to incorporate oxides such as Al₂O₃ and/or Fe₂O₃ in solid solution into the crystal, whose terminal elements are represented by γ—Al₂O₃ and/or γ—Fe₂O₃, respectively. This circumstance allows the production of the mineral mono-phase in the ternary, ternary system of MgO—Fe₂O₃—Al₂O₃, whose electrical neutrality is ensured due to cation voids in the spinel crystalline lattice.

In general, the difference in the expansion coefficient α of two or more components in a ceramic refractory product after its cooling after a sintering process, leads to the formation of micro-cracks primarily along the grain boundaries, and thus increases its ductility and/or reduces its brittleness, respectively. The mixing, shaping and sintering of burnt magnesia in the mixture with the spinel granulates according to the invention under application of common methods of production yields basic refractory materials with reduced brittleness, high ductility and outstanding alkali resistance, which is particularly superior to basic products which contain sintered or fused hercynite or sintered or fused pleonaste as an elastifier component. In contact with the fused cement clinker phases in the cement furnace, the iron-rich surface of the invented refractory products containing the spinel granulate according to the invention, causes the formation of brownmillerite, which melts at 1395° C., which contributes to a very good crust formation and thus to a very good protection of the refractory material against thermo-mechanical stresses due to the furnace charge in the furnace.

The production of the spinel used as an elastifier according to the invention is described below as an example. As was already explained above, it pertains to an iron-rich spinel from the composition range of ESS according to FIG. 1 in the ternary system of MgO—Fe₂O₃—Al₂O₃ (the spinel is hereinafter briefly called ESS).

The starting materials are at least one magnesia component, at least one iron oxide component and at least one aluminum oxide component.

The magnesia component is in particular a high purity MgO component and in particular fused magnesia and/or sintered magnesia and/or caustic magnesia. The MgO content of the magnesia component is in particular greater than 96, preferably greater than 98 wt- %.

The iron oxide component is in particular a high purity Fe₂O₃-component and in particular, natural or processed magnetite and/or hematite and/or mill scale, a byproduct of iron and steel production.

The Fe₂O₃-content of the iron oxide component is in particular greater than 90, preferably greater than 95 wt- %.

The aluminum oxide component is in particular a high purity Al₂O₃ -component and in particular, alpha and/or gamma alumina.

The Al₂O₃-content of the aluminum oxide component is in particular greater than 98, preferably greater than 99 wt- %.

These starting materials have preferably a meal fineness with grain sizes of ≤1, in particular ≤0.5 mm. They are thoroughly mixed until a homogeneous to nearly homogeneous distribution of the starting materials in the mixture is obtained.

The meal fineness and mixing of the starting materials optimum for the fusion reaction can also be produced advantageously by grinding in a grinding machine, in that at least one granular starting material with grain sizes e.g. greater than 1, for example, 1 to 6 mm, is used, which is ground down into a meal during the grinding.

The mixing of the starting materials is then treated, for example in a neutral or reducing atmosphere in an electric arc furnace in a continuous or discontinuous process, until the fusing is achieved, wherein a solid body is formed or several solid bodies are formed. Next, the material is cooled and the solid body is crushed, for example, with cone or roller crushers or similar crushing systems, so that crushed granulates are formed that can be used as an elastifier. Finally, the crushed, grainy material is fractionated, for example, by screening, into specific grain fractions. Electric arc furnaces can be used for the fusing.

The compressing of the mixture accelerates the fusing reactions and promotes a small content of secondary phases.

After fusing and cooling, when viewed mineralogically, mixed spinel crystals with Fe₂O₃ and Al₂O₃ being in solid solution and secondary phases are present, wherein the iron in the mixed crystals is present both as bivalent and also trivalent. Due to the fusing synthesis method with mixtures from the invented range, more than 50 mole- % is present as bivalent iron Fe²⁺.

The invention will be explained in greater detail below.

Two mixtures were produced as follows (data in wt- %):

| | Mixture 1 | Mixture 2 |
|---|---|---|
| Sintered magnesia | 17 | 18 |
| Alumina | 45.5 | 38 |
| Iron oxide (Magnetite) | 37.5 | 44 |

These mixtures were fused in an electric arc furnace at 2100° C., and the high temperature led to a reduction of the Fe₂O₃ in the raw material mixture.

The fused samples 1 and 2 from mixtures 1 and 2 were examined with regard to the chemical composition of the mineral constituents (x-ray powder diffraction) and with regard to micro-lattice. The results are presented in table 1 below.

TABLE 1
Chemical composition and mineral constitution of the samples (sample
1, sample 2) smelted in the (laboratory) electric arc furnace.

| | Sample 1 | Sample 2 |
|---|---|---|
| SiO₂ | 0.54 | 0.45 |
| Al₂O₃ | 45.90 | 38.61 |
| Fe₂O₃ | 35.83 | 42.21 |
| Cr₂O₃ | 0.01 | 0.02 |
| MnO | 0.03 | 0.04 |
| TiO₂ | 0.16 | 0.18 |
| V₂O₅ | 0.09 | 0.10 |
| P₂O₅ | 0.04 | 0.03 |
| CaO | 0.34 | 0.26 |
| MgO | 16.89 | 17.94 |
| K₂O | 0.00 | 0.00 |
| Na₂O | 0.06 | 0.02 |
| Loss on ignition | − | − |
| Gain on ignition | 1.64 | 1.91 |
| Mineral constitution | | |
| Spinel S2¹⁾ | +++ | +++ |
| Spinel S1²⁾ | + | + |
| Wustite | + | + |
| Periclase | ? | ± |

− = not detected,
? = not unambiguously detected,
± = trace,
+ = detected,
++ = considerable content,
++++ = detected as main phase
¹⁾Spinel S1 (MgFe₂O₄ss)
²⁾Spinel S2 (MgAl₂O₄ss))

The fused material of samples 1 and 2 comprises a significant gain on ignition (1 to 2 wt- %). This confirms that a considerable fraction of the iron in the fused product is present in the bivalent form (Fe²⁺). The presence of bivalent iron (Fe²⁺) is a consequence of the reduction of the iron oxide component (Fe³⁺→Fe²⁺) in the fusing process in the electric arc furnace.

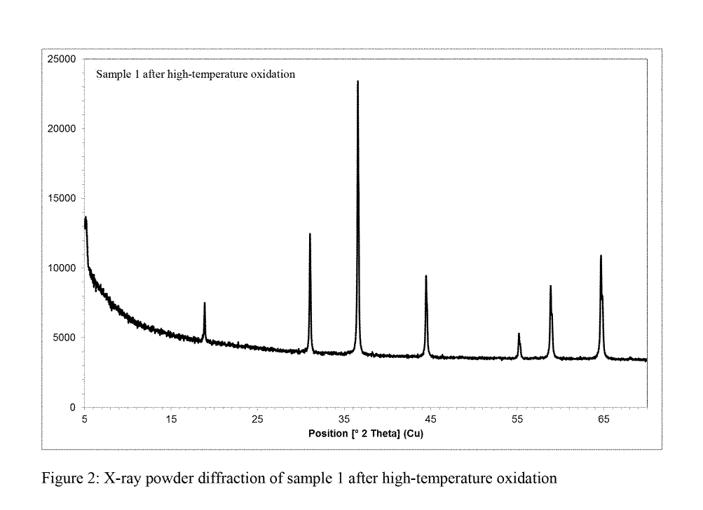

Sample 1 was subjected to a high temperature oxidation. The x-ray powder diffractogram of this sample 1 is shown in FIG. 2.

The reflexes of sample 1 have a low half-value width. The positions and intensities of the reflexes can be explained by a single spinel phase.

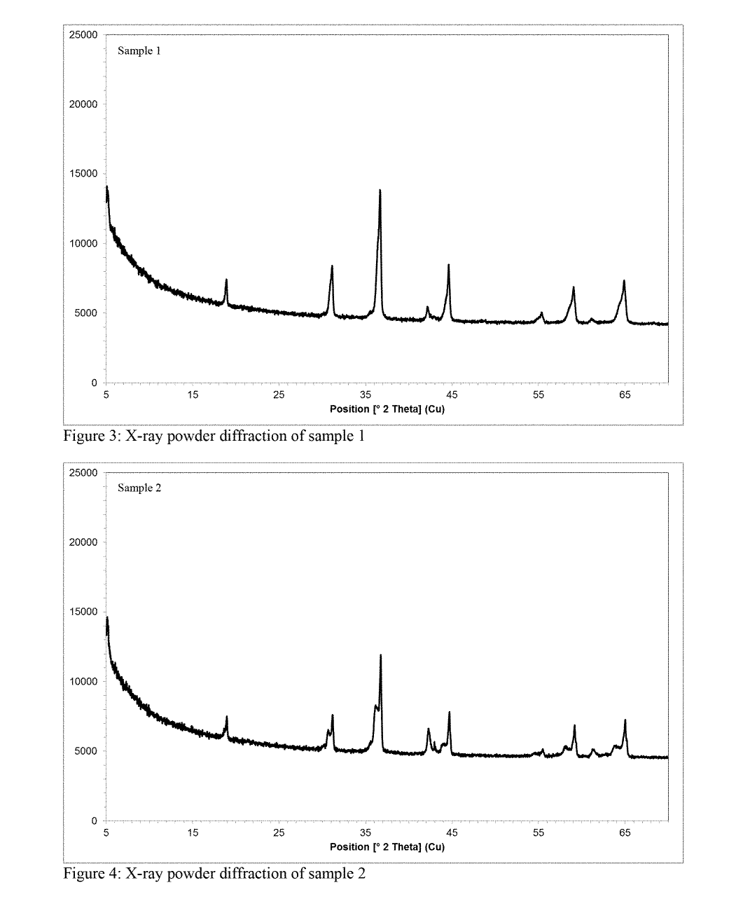

In contrast thereto, FIGS. 3 and 4 show x-ray powder diffractograms of samples 1 and 2 which were not subjected to a high temperature oxidation, but are rather only the fused samples. The reflexes in comparison to the x-ray powder diffractogram according to FIG. 2 are less well-defined and have larger half-value widths. The positions and intensities of the reflexes can be explained by the coexistence of two spinel phases (spinel 51 (MgFe₂O₄ₛₛ) or spinel S2 (MgAl₂O₄ₛₛ)), and also Wüstite and traces of periclase.

When using fused spinel granulates as an elastifiers in refractory products, the granulates have merely an elastifying effect in a reducing atmosphere, and partly also in a neutral atmosphere, whereas in situ, at high temperatures and oxidizing atmosphere, they are converted into a particular mono-phase which ensures a high oxidation resistance, a very good elasticity and a very good corrosion resistance, and also a very good crust formation in a cement rotary kiln.

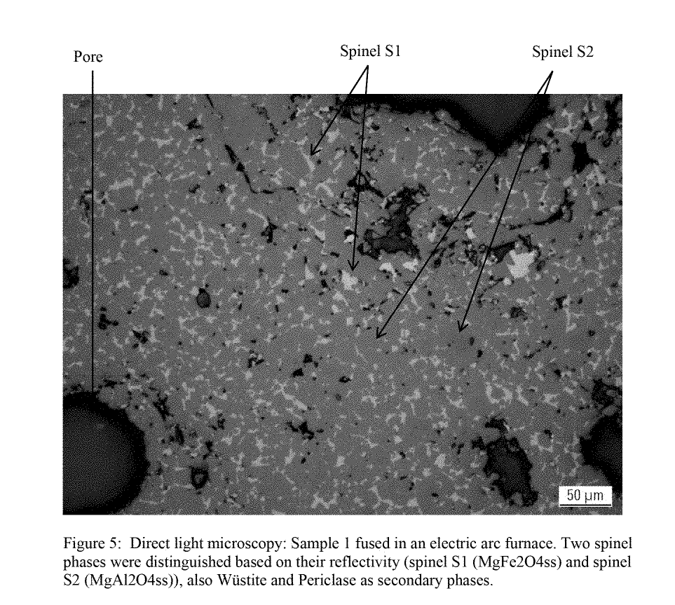

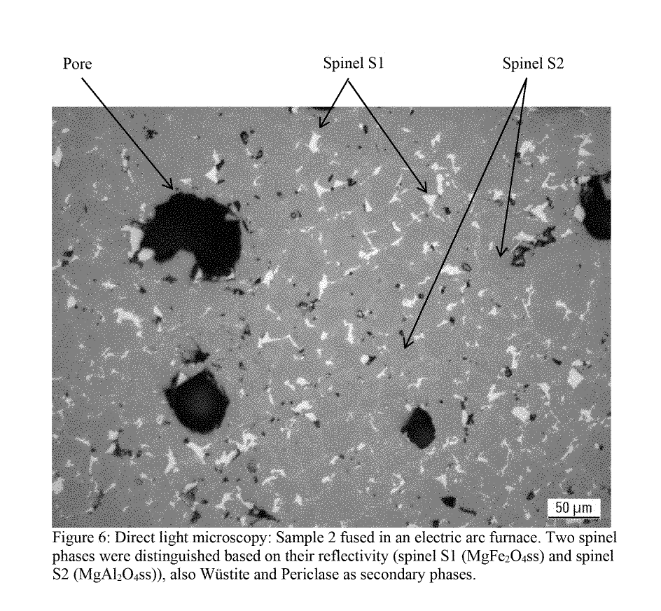

The samples fused in the electric arc furnace are multi-phased. In addition to spinel phases (spinel S1 (MgFe₂O₄ₛₛ) or spinel 2 (MgAl₂O₄ₛₛ)), Wüstite and periclase can be detected by means of x-ray powder diffraction. The micro-lattices also indicate that the fused products are multi-phased. This is shown in FIGS. 5 and 6. These pertain to images from the incident light microscope. Different phases can be clearly differentiated based on their reflection capacity.

Under reducing conditions during the fusing process in the electric arc furnace, Fe³⁺is reduced to Fe²⁺. Thus, the number of bivalent cations (Mg²⁺, Fe²⁺) increases. Finally, the ratio of trivalent cations (Al³⁺, Fe³⁺) and bivalent cations is no longer sufficient for the spinel lattice—instead of a single phase, two spinel phases and additional phases (Wüistite, Periclase) are produced.

Under the usually oxidizing conditions of the furnace, for example, to produce elasticizing magnesia bricks in the temperature range from 1400° C. to 1700° C., in situ a homogeneous spinel phase forms from the multi-phased fused product.

If the fused product is used for the production, for example, of magnesia bricks to be elastified, then during the ceramic firing and/or during the production firing, an elastifying effect will occur.

The same thing also happens in situ to refractory products installed in a furnace lining in the non-fired form, which according to the invention comprise spinel fused granulates as an elastifier.

The invention also relates to basic, refractory products, e.g. basic refractory shaped bodies and basic refractory masses, which comprise 50 to 95 wt- %, in particular 60 to 90 wt- %, of at least one granular, basic refractory material, in particular magnesia, in particular fused magnesia and/or sintered magnesia with grain sizes for example between 1 and 7, in particular between 1 and 4 mm, and also 5 to 20 wt- %, in particular 6 to 15 wt- % of at least one granular elastifier according to the invention, with grain sizes for example, between 0.5 and 4, in particular between 1 and 3 mm, wherein 0 to 20 wt- %, in particular 2 to 18 wt- % of at least one powdery basic, refractory material, in particular magnesia, in particular fused magnesia and/or sintered magnesia with grain sizes ≤1 mm, in particular≤0.1 mm, and 0 to 5, in particular 1 to 5 wt- % of at least one powdery spinel according to the invention, as additive with grain sizes ≤1 mm, in particular ≤0.1 mm and 0 to 5, in particular 1 to 2 wt- % of at least one binder known for refractory products, in particular at least one organic binder such as lignin sulfonate, dextrin, methyl cellulose can be contained.

The invention is characterized in particular by a granular elasticizer in the form of a crushed granulate for refractory products, in particular for basic refractory products, minerally consisting of mono-phased fused spinel mixed crystals of the ternary system MgO—Fe₂O₃—Al₂O₃ of the composition range
MgO: 12 to 19.5, in particular 15 to 17 wt.- %,
Remainder: Fe₂O₃ and Al₂O₃ in a quantity ratio range of Fe₂O₃ to Al₂O₃ between 80 to 20 and 40 to 60 wt.- %.
   wherein, starting from an MgO content between 12 and 19.5 wt.- %, the respective mixed crystals have an Fe₂O₃ and Al₂O₃ content in a solid solution from the limited ranges indicated for each case, such that a total composition of 100 wt- % is obtained.

Furthermore it is an advantage if the elasticizer comprises:

a grain bulk density of ≥3.5, in particular ≥3.6, preferably ≥3.7 g/cm³, quite particularly up to 3.8 g/cm³, measured according to DIN EN 993-18
or
   less than 15, in particular less than 10 wt-% of secondary phases
or
   grain compressive strengths between 30 MPa and 50 MPa, in particular between 35 MPa and 45 MPa, measured with reference to DIN EN 13005-Appendix C
or
   linear coefficients of expansion a between 8.5 and 9.5, in particular between 8.8 and 9.2
   ·10−6⁻¹ K⁻¹
or
   grain size distribution between 0 and 6, in particular between 0 and 4 mm, preferably with the following grain distributions, each with commonly standard grain distributions, in particular Gaussian grain distributions, or with certain, selected grain fractions and/or grain bands.
0.5-1.0 mm 30-40 wt.- %
1.0-2.0 mm 50-60 wt.- %

The invention is characterized in particular also by a method for producing of a mono-phased sintered spinel, wherein
at least one high purity, in particular powdered MgO component
at least one high purity, in particular powdered Fe₂O₃-component
at least one high purity, in particular powdered Al₂O₃-component
   are mixed in certain quantities residing in the composition range relative to the oxides according to claim 1, and the mixture is fused in a neutral or reducing atmosphere, e.g. in an electric arc furnace, after cooling of the melt the fused product is crushed into a granulate and classified, and then preferably thereafter the classified or as yet still unclassified granulate of a high-temperature oxidation, for example in situ as an elastifying component of a refractory product, is converted into a mono-phased spinel constituent of a refractory product.

It is also an advantage if the following method parameters are used:
as MgO component at least one starting material from the following group is used: sintered magnesia, caustic magnesia, in particular with MgO contents greater than 96, preferably greater than 98 wt- %,
as Fe₂O₃-component at least one starting material from the following group is used: magnetite or hematite, in particular with Fe₂O₃-contents greater than 90, preferably greater than 95 wt- %
as Al₂O₃-component at least one starting material from the following group is used: alpha and/or gamma alumina, in particular with Al₂O₃ contents greater than 98, preferably greater than 99 wt- %, preferably alpha and gamma alumina.

Instead of the pure, premium primary raw materials normally used, also granulates from recycling materials can be used, such as mill scale (Fe₂O₃) or recycled magnesia stone (MgO) or magnesia-spinel stones (Al₂O₃, MgO), at least in partial quantities.

Furthermore it is an advantage that the components are crushed and mixed with grinding energy in a grinding machine, preferably to 1 mm.
or
   the mixtures are fused at temperatures between 1750 and 2200, in particular between 1800 and 2100° C.
or
   the mixtures are compacted before fusing, e.g. by granulation or compression.

The invention also pertains to a basic, ceramic fired or non-fired refractory product in the form of refractory shaped bodies, in particular compressed, shaped refractory bodies, or in the form of non-shaped refractory masses comprising, in particular consisting of
50 to 95 wt- %, in particular 60 to 90 wt- % of at least one granular, basic, refractory material, in particular magnesia, in particular fused magnesia and/or sintered magnesia, with grain sizes e.g. between 1 and 7, in particular between 1 and 4 mm;
0 to 20, in particular 2 to 18 wt- % of at least one powdered, basic, refractory material, in particular magnesia, in particular fused magnesia and/or sintered magnesia with grain sizes ≤1 mm, in particular ≤0.1 mm;
5 to 20, in particular 6 to 15 wt- % of at least one granular elasticizing granulate according to the invention, with grain sizes e.g. between 0.5 and 4, in particular between 1 and 3 mm;
0 to 5, in particular 1 to 5 wt- % of at least one powdered additive, e.g. from a powdered fused spinel produced according to the invention with grain sizes ≤1 mm, in particular ≤0.1 mm; and
0 to 5, in particular 1 to 2 wt- % of at least one binder known for refractory products, in particular with at least one organic binder such as lignin sulfonate, dextrin, methyl cellulose, etc.

The refractory products according to the invention containing the elastifier granulates according to the invention are suitable in particular for use as the fire-side lining of industrial, large-volume furnace systems which are operating with a neutral and/or oxidizing furnace atmosphere, in particular for the lining of cement rotary kilns.

Within this specification, embodiments have been described in a way which enables a clear and concise specification to be written, but it is intended and will be appreciated that embodiments may be variously combined or separated without parting from the invention. For example, it will be appreciated that all preferred features described herein are applicable to all aspects of the invention described herein.

While the above description constitutes the preferred embodiments of the present invention, it will be appreciated that the invention is susceptible to modification, variation and change without departing from the proper scope and fair meaning of the accompanying claims.

What is claimed is:

1. A granular, refractory mineral elasticizing granulate for refractory products, the elasticizing granulate comprising a ternary system MgO—Fe₂O₃—Al₂O₃ as a mono-phased fused spinel mixed crystal or a multi-phased fused product, the ternary system MgO—Fe₂O₃—Al₂O₃ having a composition with the following range:
MgO: 12 to 19.5 wt.- %,
Remainder: Fe₂O₃ and Al₂O₃ in a quantity ratio range of Fe₂O₃ to Al₂O₃ between 80 to 20 and 40 to 60 wt.- %,
wherein starting from an MgO content between 12 and 19.5 wt.- %, the mixed crystal having an Fe₂O₃ and Al₂O₃ content in solid solution out of the limited ranges respectively indicated thereof, such that a total composition of 100% is obtained.

2. The elasticizing granulate according to claim 1, wherein the elasticizing granulate has a bulk density of ≤3.5, measured according to DIN EN 993-18.

3. The elasticizing granulate according to claim 1, wherein the elasticizing granulate has less than 15 wt- % of secondary phases.

4. The elasticizing granulate according to claim 1, wherein the elasticizing granulate has a grain compressive strength between 30 MPa and 50 MPa, measured with reference to DIN EN 13005.

5. The elasticizing granulate according to claim 1, wherein the elasticizing granulate has a linear coefficient of expansion between 8.5 and 9.5·10−6 K−1.

6. The elasticizing granulate according to claim 1, wherein the elasticizing granulate has grain sizes between 0 and 6 mm, with the following grain distributions under Gaussian grain distributions:
0.5-1.0 mm 30-40 wt.- %
1.0-2.0 mm 50-60 wt.- %.

7. A method for producing the mono-phased elasticizing granulate according to claim 1, the method comprising:
mixing
at least one high purity powdered MgO component
at least one high purity powdered Fe₂O₃-component, and
at least one high purity powdered Al₂O₃-component
in the composition range according to claim 1,
fusing the mixture in a neutral or reducing atmosphere to a fused product,
cooling the fused product,
crushing the fused product into a granulate and classified, and
converting the granulate via high-temperature oxidation into the mono-phased spinel product.

8. The method according to claim 7, wherein
at least one raw material for the MgO component is selected from the group consisting of: fused magnesia, sintered magnesia, caustic magnesia, with MgO contents greater than 96 wt- %, and an iron-rich, alpine sintered magnesia,
at least one raw material for the Fe₂O₃ component is selected from the group consisting of magnetite, hematite, and mill scale, with Fe₂O₃-contents greater than 90 wt- %, and
at least one raw material for the Al₂O₃ component is selected from the group consisting of: aluminum oxide in the form of alpha or gamma alumina with Al₂O₃ contents greater than 98 wt- % and calcined metallurgical bauxite.

9. The method according to claim 7 wherein the components are mixed and/or crushed in a grinding machine to ≤1 mm.

10. The method according to claim 7, wherein the mixtures are fused at temperatures between 1,750 and 2,200° C.

11. The method according to claim 7, wherein the mixtures are compacted before fusing by granulation or compression.

12. A basic, ceramic fired or non-fired refractory product in the form of shaped refractory bodies, or in the form of non-shaped refractory masses, the refractory product comprising:
50 to 95 wt- % of at least one granular, basic, refractory material, with grain sizes between 1 and 7 mm;
0 to 20 wt- % of at least one powdered, basic, refractory material, with grain sizes ≤1 mm;
5 to 20 wt- % of at least one granular elasticizing granulate with grain sizes between 0.5 and 4 mm;
0 to 5 wt- % of at least one powdered additive with grain sizes ≤1 mm; and
0 to 5 wt- % of at least one binder normally used for refractory products.

13. (canceled)
